(19) United States
(12) Patent Application Publication
(10) Pub. No.: US 2017/0138904 A1
(43) Pub. Date: May 18, 2017

(54) ION MOBILITY SEPARATION DEVICE

(71) Applicant: SHIMADZU CORPORATION, Kyoto-shi (JP)

(72) Inventor: Yoshihiro UENO, Kyoto-shi (JP)

(73) Assignee: SHIMADZU CORPORATION, Kyoto-shi (JP)

(21) Appl. No.: 15/338,752

(22) Filed: Oct. 31, 2016

(30) Foreign Application Priority Data
Nov. 17, 2015 (JP) 2015-224380

(51) Int. Cl. G01N 27/62; G01N 27/447

(52) U.S. Cl. CPC G01N 27/622; G01N 27/447

(57) ABSTRACT

A drift voltage generator under the control of the control unit applies a rectangular waveform voltage to each annular electrode so as to form alternately in times a uniform accelerating electric field for accelerating the ions introduced to the drift region toward the end of the drift tube and a uniform decelerating electric field for decelerating the ions. The control unit adjusts the duty ratio of the rectangular waveform voltage according to the preset degree of separation. By forming a decelerating electric field periodically, the average movement speed of ions becomes slow compared to the case of forming an accelerating electric field continuously. Thereby, the drift time becomes longer despite of the same drift distance, enlarging the difference of time for the two types of ions having different mobility to arrive at the detector, improving the degree of separation.

### TECHNICAL FIELD

The present invention pertains to an ion mobility separation device for separating ions originating from a sample component depending on the ion mobility.

### BACKGROUND ART

When molecular ions generated from sample molecules are moved in a medium gas (or liquid) by the action of an electric field, the ions move at a constant speed depending on the mobility determined by the size of the molecule and the strength of the electric field. Ion Mobility Spectrometry (IMS) technique is a measurement technique using this mobility for analyzing sample molecules (refer to Non-Patent Literature 1). IMS technique is used to prepare an ion mobility spectrum by detecting various ions originating from a sample after separation depending on their ion mobility, and is often used together with a mass spectrometer as disclosed in Non-Patent Literature 2 and other references.

A typical ion mobility separation device for separating various ions depending on their mobility has a drift tube in which a plurality of annular electrodes of the same shape is arranged therein along the central axis, wherein ions originating from the sample components are pulsed and sent into the space inside the drift tube, as disclosed in the Non-Patent Literature 2 and other references. A DC electric field (static electric field) having a potential gradient with a constant inclination in the central axis is formed in a space inside the drift tube by a voltage applied to each of the plurality of annular electrodes. The ions accelerate and drift in the axial direction by the action of the electric field. The gas pressure inside the drift tube is relatively high, which is from about substantially atmospheric pressure to about hundred Pa, and the ions travel while colliding with this gas. For this reason, the movement speeds (drifting speeds) of ions in the axial direction converge at a constant speed depending on the ion mobility, and the ions are separated in their travelling direction depending on their mobility.

Such ion mobility separation device improves the degree of separation with respect to two types of ions having their mobilities close to each other, the longer the distance the ion drifts. For this reason, the drift tube may be lengthened linearly in order to increase the degree of separation of ions. However, the device becomes large, and so does the amount of annular electrodes for that portion only, raising the cost. On the other hand, with the device disclosed in Non-Patent Literature 3, a drift tube in a round shape is used to lengthen the distance of drift by repeating the drift of ions with the same trajectory. However, such device has a complicated configuration and control, so the cost becomes more expensive even when it is possible to avoid the device from becoming large in size.

[Prior Art Literatures]

[Non-Patent Literatures]

(Non-Patent Literature) Sugai, “Binding of ion mobility and mass spectrometry, current mass spectrometry,” Kagaku Dojin, issued on Jan. 15, 2013, p. 213-p. 228.

(Non-Patent Literature 2) “Agilent ion mobility Q-TOF mass spectrometry system,” (online), (search on Oct. 26, 2015), Agilent Technologies, Inc., Internet <URL: http://www.chem-agilent.com/pdf/low 5991-3244JAJP.pdf>

(Non-Patent Literature 3) Samuel (Samuel I. M.), three other authors, “High-Resolution Ion Cyclotron Mobility Spectrometry,” Analytical Chemistry (Anal. Chemistry), Vol. 81, No. 4, 2009, pp. 1482-1487.

### SUMMARY OF THE INVENTION

### Problems to be Solved by the Invention

The present invention was made to solve the problems described above, and the objective of the present invention is to provide an ion mobility separation device small in size, low in cost, and capable of improving the degree of ion separation.

### Means for Solving the Problem

The first embodiment of the present invention made to solve the problems described above is an ion mobility separation device for separating ions in their travelling direction depending on the ion mobility by introducing pulsed ions into a drift region to allow drifting, and the device is equipped with
a) one or a plurality of electrodes for forming an electric field having a predetermined potential gradient in the central axis in the drift region,
b) a voltage applying unit for selectively applying to one or a plurality of electrodes an accelerating voltage so as to form in the drift region an accelerating electric field for accelerating ions introduced into the drift region along the central axis, and a decelerating voltage so as to form in the drift region a decelerating electric field for decelerating ions along the central axis, and
c) a control unit for controlling the voltage applying unit so as to repeat one cycle of applying a decelerating voltage for a second predetermined period after applying an accelerating voltage for a first predetermined period to one or the plurality of electrodes described above, and for adjusting the ratio between the first predetermined period and the second predetermined period in that one cycle.

The second embodiment of the present invention made to solve the problems described above is an ion mobility separation device for separating ions in their travelling direction depending on the ion mobility by introducing pulsed ions into a drift region to allow drifting, and the device is equipped with
a) one or a plurality of electrodes for forming an electric field having a predetermined potential gradient in the central axis in the drift region,
b) a voltage applying unit for selectively applying to one or a plurality of electrodes an accelerating voltage so as to form in the drift region an accelerating electric field for accelerating the ions introduced into the drift region along the central axis, and a decelerating voltage so as to form in the drift region a decelerating electric field for decelerating the ions along the central axis, and
c) a control unit for controlling the voltage applying unit so as to repeat one cycle of applying a decelerating voltage for a second predetermined period after applying an accelerating voltage for a first predetermined period to one or the plurality of electrodes, and for adjusting at least one value of the accelerating voltage and decelerating voltage.

The ion mobility separation device according to the present invention can also be configured by separating ions depending on the ion mobility in the drift region and detecting them by a detector; however, it may also be configured by further introducing the ions that have been separated depending on the ion mobility to a mass spectrometer and separating them depending on their mass-to-charge ratio, and then detecting them. That is, the ion mobility separation device according to the present invention can also be used in the ion-mobility spectrometry-mass spectrometry (IMS-MS).

In the ion mobility separation device according to the present invention, the accelerating electric field and the decelerating electric field may both be a uniform electric field, that is, an electric field with a linear potential gradient on the ion optical axis.

In this type of typical ion mobility separation device, a uniform accelerating electric field is formed in a drift region for drifting the ions. Therefore, the ions introduced into the drift region continuously receive an acceleration energy, and the movement speeds of ions converge substantially constant with a deprived energy by the collision with gas.

On the contrary, with the ion mobility separation device according to the present invention, an accelerating electric field and a decelerating electric field are formed alternately in time in the drift region by the voltage applied to the electrode from the voltage applying unit under the control by the control unit. For this reason, the accelerating energy imparted to ions by an accelerating electric field is deprived not only by the collision with gas but also by the decelerating electric field. As long as the cycle of repeating the accelerating electric field and the decelerating electric field is short enough compared to the drift time of ions, it is possible to consider that the ions advance at a constant speed, and its movement speed also depends on the ion mobility as well as the difference between the energy received from the electric field during the formation of the accelerating electric field and the energy deprived by the electric field during the formation of the decelerating electric field. These energies are proportional to the product of the strength of the electric field and the time the electric field occurs.

In the ion mobility separation device of the first embodiment of the present invention, the control unit adjusts the energy imparted or deprived during one cycle by adjusting the ratio of the first predetermined period and the second predetermined period in one cycle, that is, the duty ratio. On the other hand, with the ion mobility separation device of the second embodiment of the present invention, the control unit adjusts the strength of the electric field by adjusting at least one of the voltage values of the accelerating voltage and the decelerating voltage, and adjusts the energy imparted or deprived in one cycle. Thereby, in either embodiment, it is possible to make the average movement speed of ions lower than the movement speed in the conventional ion mobility separation devices. When the movement speed of ions becomes low, the drift time becomes longer when the ions drift at the same distance. This is because it is substantially the same as extending the drift distance at the same movement speed; the time difference of the drift time with respect to the two types of ions with different ion mobility becomes significant, improving the degree of separation.

With the ion mobility separation device according to the present invention, the longer the period during which a decelerating electric field is formed in one cycle (as a matter of course, in the range in which the speed at which the ions advance in the terminal direction of the drift tube can be obtained), the higher the degree of separation of ions depending on the ion mobility becomes. On the other hand, the time required for one-time measurement becomes long because the drift time of ions becomes long, decreasing the throughput of the measurement. That is, the degree of separation of ions and the required measurement time are in a trade-off relationship. For this reason, it is preferable to perform a measurement with a balance between the degree of separation and the required measurement time depending on the types of samples to be measured and the purpose of measurement.

In the ion mobility separation device according to the present invention, a setter for allowing a user to set a separation performance of ions is further preferably installed in the device, the control unit may be of a configuration in which the ratio between the first predetermined period and the second predetermined period is adjusted depending on the separation performance set by the setter, or at least one of the values of the accelerating voltage and the decelerating voltage is adjusted.

According to this configuration, by allowing a user (the user of the device) to properly perform the adjustment manually, for example, it is possible to perform a measurement by separating the ions having ion mobility close to each other at high degree of separation, although the measurement takes time, and to avoid overlooking the ions originating from the components in the sample continuously supplied by increasing the repetition cycle of the measurement of a relatively low degree of separation.

### Effect of the Invention

According to the ion mobility separation device of the present invention, it is possible to improve the degree of separation of ions based on the ion mobility by simply changing the voltage to be applied to the electrode for forming the electric field in the drift region without lengthening the drift region in which the ions drift. For this reason, it is possible to avoid enlarging the device and increasing the cost accompanied with the structure being complicated, achieving high performance.

### BRIEF DESCRIPTION OF THE DRAWINGS

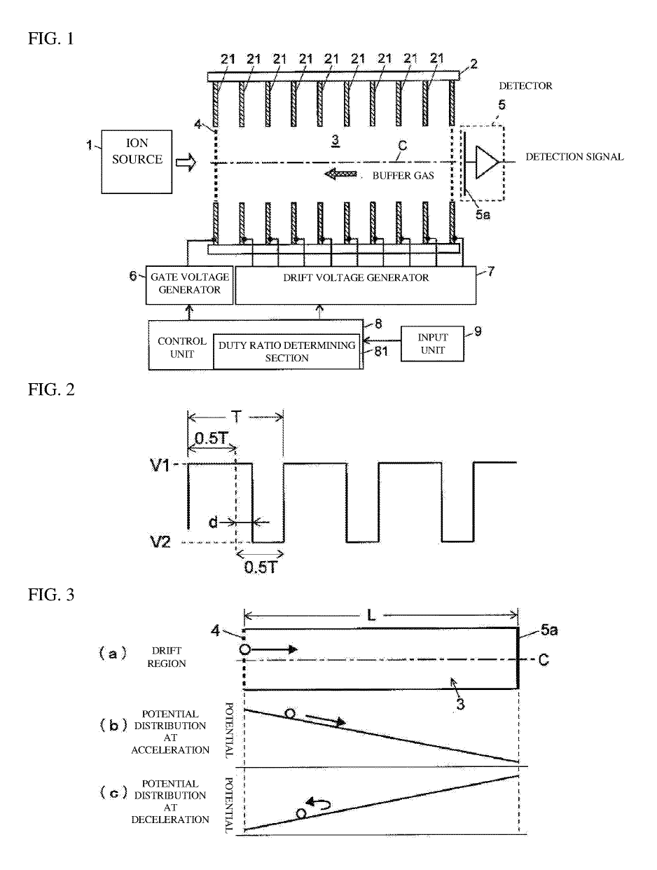

(FIG. 1) is a schematic diagram of an ion mobility separation device according to one example of embodiment of the present invention.

(FIG. 2) is a drawing illustrating one example of a voltage waveform applied to the annular electrode in the ion mobility separation device according to the present invention.

(FIG. 3) is a schematic diagram of the potential distribution on the central axis in the drift region in the ion mobility separation device of the present example of embodiment.

### EMBODIMENT FOR CARRYING OUT THE INVENTION

One example of embodiment of the ion mobility separation device according to the present invention will be described with reference to the drawings.

FIG. 1 is a schematic diagram of the ion mobility separation device of the present example of embodiment.

The ion mobility separation device of the present example of embodiment is equipped with an ion source 1 for generating ions originating from the sample components, a drift tube 2 in which a plurality of annular electrodes 21 in the same shape are arranged therein along the ion optical axis (central axis) C, a gate electrode 4 arranged at the entrance end of the drift tube 2, a detector 5 arranged on the outer side of the exit end of the drift tube 2, a gate voltage generator 6 for applying a pulse voltage to the gate electrode 4 at a predetermined timing, a drift voltage generator 7 for applying a predetermined voltage each to a plurality of annular electrodes 21, a control unit 8 for controlling each of the voltage generators 6 and 7 and that includes a duty ratio determination section 81 as a functional block, and an input unit 9 for allowing a user to set analysis conditions such as degree of separation, and so on. The space on the inner side of the inner peripheral edge of the annular electrodes 21 is the drift region 3 in which ions drift. A flow of buffer gas is formed in this drift region 3 at a constant flow rate from the outlet toward the inlet of the drift tube 2, and the gas pressure of the drift region 3 by the gas is maintained at substantially atmospheric pressure (or in a low-vacuum state at about several hundred Pa).

The operation at the time of measurement in the ion mobility separation device of the present example of embodiment will be described in details.

The ion source 1 ionizes the components in the sample introduced from outside by means of a predetermined ionization method and generates ions derived from the sample components. This ionization method is not particularly limited. Under the control by the control unit 8, the gate voltage generator 6 applies a voltage that holds back ions, for example, a voltage with large positive polarity in the case of positive ion, to the gate electrode 4, accumulating ions in front of the gate electrode 4. And then, the voltage at which the ions pass through is applied to the gate electrode 4 only for a short time at a predetermined timing. Thereby, the stored ions accumulate, pass through the gate electrode 4 in pulses, and are introduced to the drift region 3. Such ion introduction to the drift region 3 is the same as in the case of the typical conventional ion mobility separation devices.

The ion mobility separation device of the present example of embodiment is significantly different from the conventional devices in that a voltage from the drift voltage generator 7 is applied to each annular electrode 21 at the time of separating ions depending on the ion mobility. FIG. 2 is a drawing illustrating one example of a voltage waveform applied to the annular electrode 21 in the ion mobility separation device of the present example of embodiment, and FIG. 3 is a schematic drawing of the potential distribution on the ion optical axis C in the drift region 3.

With typical ion mobility separation devices conventionally used, as shown in FIG. 3(b), an accelerating electric field in which the potential gradient on the ion optical axis C is a constant downward slope, i.e., a uniform accelerating electric field is continuously formed in the drift region. On the contrary, in the ion mobility separation device of the present example of embodiment, as shown in FIG. 3(b), a uniform accelerating electric field in which the ions introduced to the drift region 3 are accelerated in the direction parallel to the ion optical axis C toward the end of the drift tube 2 and a uniform decelerating electric field in which the ions are decelerated in the direction parallel to the ion optical axis C, as shown in FIG. 3(c), are formed alternately in time.

To be specific, immediately after the gate electrode 4 is opened in a short amount of time, and the ions in a packet form pass through the gate electrode 4, the drift voltage generator 7 under the control of the control unit 8 applies to each annular electrode 21 for a predetermined time (0.5+d) T a voltage at which a uniform accelerating electric field E+ is formed so as to advance in the downstream direction (right-side direction in FIG. 1 and FIG. 3(a). T represents the time of one cycle, and d represents a duty ratio (where 0≦d≦0.5). As a matter of course, the value of the voltage applied to the annular electrode 21, i.e., the value of V1 in FIG. 2, varies at each electrode 21. FIG. 3(b) is a potential distribution on the ion optical axis C of the accelerating electric field E+ formed in the drift region 3 at this point. Thereby, the potential gradient becomes in a constant downward slope from the gate electrode 4 toward the detection surface 5a of the detector 5. This is the same as the conventional uniform electric accelerating field.

Then, a voltage that forms a decelerating electric field E− that decelerates ions so as to advance the ions in the upstream direction (left-side direction in FIG. 1) is applied to each annular electrode 21 for a predetermined time (0.5−d) T. The value of the voltage applied to the annular electrode 21 at this point, i.e., the value of V2 in FIG. 2, varies for each electrode 21. FIG. 3(c) is a potential distribution on an ion optical axis C of a decelerating electric field E− formed in the drift region 3 at this point. In this way, the potential gradient becomes a constant upward slope from the gate electrode 4 toward the detection surface 5a of the detector 5.

The application of voltage for forming the accelerating electric field E+ and the application of voltage for forming the decelerating electric field E− are set as one cycle, and this cycle is repeated. That is, as shown in FIG. 2, rectangular waveform voltages, in which V2 is a low level voltage and V1 is a high level voltage, are applied to the annular electrodes 21. The values of V1 and V2 differ according to the position of the annular electrode 21; however, the fact that the applied voltage is in a rectangular waveform is the same.

The behavior of ions in the drift region 3 will be explained, when the accelerating electric field and the decelerating electric field are formed alternately in time. Assumed here is the case of two types of ions M^{N+} and mⁿ⁺ having different ion mobility. K_{M} represents the mobility of ion M^{N+}, V_{M+} represents the movement speed in the downstream direction, V_{M-} represents the movement speed in the upstream direction, and V_{Mg} represents the speed change received according to the buffer gas flow. Similarly, Kₘ represents the mobility of ion mⁿ⁺, Vₘ₊ represents the movement speed in the downstream direction, V₋ represents the movement speed in the upstream direction, and V_{mg} represents the speed change received by the buffer gas flow. At this point, the movement speeds of the respective ions M^{N+} and mⁿ⁺ in the drift region 3 are expressed as follows.

V_{M+}K_{M}E₊−V_{Mg}

V_{M-}=K_{M}E₋−V_{Mg}

Vₘ₊=KₘE+−V_{mg}

Vₘ₋=KₘE₋−V_{mg}

To simplify the explanation, the strength of the accelerating electric field and the decelerating electric field are set to be the same. In this case, E+=E−. The ions receive an energy according to the accelerating electric field for time T, which is one cycle, while being deprived of energy by the decelerating electric field; however, as long as one cycle is sufficiently smaller than the entire drift time, it can be assumed that the average movement speed of ions becomes the difference between the movement speed in the downstream direction and the movement speed in the upstream direction. For this reason, the distant S_{M} at which the ions M^{N+} advance for time T (one cycle) is expressed by the following equation (1).

S_{M}=(2dK_{M}E+−V_{Mg})T (1).

Similarly, the distant Sₘ at which the ions mⁿ⁺ advance for time T is expressed by the following equation (2).

Sₘ(2dKₘE₊−V_{mg})T (2)

Therefore, the times required for the two types of ions described above to advance for a distance L, i.e., drift times T_{M} and Tₘ, are represented by the following equations.

T_{M}=(L/S_{M})T

Tₘ=(L/Sₘ)T

Thereby, the difference in time ΔT in which the ions arrive at the detection surface 5a, which is the position away from the gate electrode 4 at distance L only, is expressed by the following equation (3).

ΔT=T_{M}−Tₘ=L{1/(2dK_{M}E₊−V_{Mg})−1/(2dKₘE₊−V_{mg})} (3)

Here, when the velocity change due to the effect of the flow of buffer gas is small to the extent that it can be ignored, 2d K_{M}E+>>VMg and 2d KₘE+>>Vmg are possible. Thus, equation (3) can be approximately rewritten to equation (4).

The equation (4) above refers to the ability to adjust the difference ΔT of the arrival time of two types of ions to the detection surface 5a by adjusting the duty ratio d of the rectangular waveform voltage as shown in FIG. 2. The degree of separation by the ion mobility is in proportional to this time difference ΔT. Therefore, from the equation (4), the degree of separation of ions depends on the duty ratio d of the rectangular waveform voltage applied to the annular electrode 21, and a high degree of separation can be realized by adjusting the duty ratio d (d close to 0). From equation (4), the strength of the electric field (E+=E−) is changed while maintaining the strength of the accelerating electric field and the decelerating electric field to be the same. In other words, it was found that the difference of the ion arrival time can be adjusted by changing the inclination of the potential gradient as shown in FIGS. 3(b) and (c). Therefore, instead of changing the duty radio d, changing the voltage value itself of the rectangular waveform voltage applied to the annular electrode 21 can also increase the degree of separation.

Since measurement is not possible if the average movement speed of ions, i.e., the right side of the equations (1) and (2), is not the correct value, it is necessary to meet the requirement of 2 d K_{M}E+−V Mg>0 and 2 d KₘE+−V mg>0, and this will specify the lower limit (the upper limit being 0.5) of the duty ratio d. Thereby, there is a limit in increasing the degree of separation. In addition, the upper limit of the cycle is for the distances S_{M} and Sₘ at which the ions represented by the equations (1) and (2) advance not to exceed the distance L, that is, S_{M}<L and Sₘ<L are met, while the lower limit of the cycle is for the time equivalent δT of the size of ion spread due to diffusion not to exceed the value of the equation (3), that is δT<ΔT is met.

The effect of the velocity change due to the flow of buffer gas was ignored during the calculation described above; actually, it is acceptable without the flow of buffer gas, or as shown in FIG. 1, the buffer gas may be made to flow towards the downstream side instead of flowing towards the upstream side of ions. Furthermore, even in the case of strong buffer gas flow from which the effect of the velocity change due to the buffer gas flow can no longer be ignored, the degree of separation can also be increased compared to that in the conventional devices. However, in such case, the lower limit of the duty ratio d becomes larger while the range in which d can be taken becomes narrower in order to fulfill the requirement that the average movement speed of ions as described above is to be a correct value.

The explanation will continue by returning to FIG. 1. As described above, properly determining the duty ratio within a predetermined range can increase the degree of separation of ions compared to those by the conventional devices; however, the drift time also becomes longer. In the case of repeating the task of introducing the ions generated by the ion source 1 to the drift region 3 in pulses and measuring the drift time of the ions introduced, when the drift time becomes longer, the time required for one-time measurement also becomes longer, causing the repeated measurement cycle to become longer, which is a drawback. Therefore, increasing the degree of separation more than necessary is not necessarily desirable. Therefore, with the ion mobility separation device of the present example of embodiment, a user is allowed to set the degree of separation from the input unit 9, and the duty ratio determining section 81 determines the duty ratio d depending on the preset degree of separation. In order to easily determine the duty ratio from the degree of separation, for example, the relationship between the duty ratio and the degree of separation of ions by preliminary measurement is obtained to be presented as a mathematical equation or a table, and the duty ratio can be derived by referring to this [equation or table].

When the duty ratio d has been determined, the control unit 8 controls the drift voltage generator 7 so as to apply to the annular electrode 21 the rectangular waveform voltage according to its duty ratio d. Thereby, the rectangular waveform voltage having its duty ratio d adjusted so as to achieve the degree of separation desired by a user is applied to the annular electrode 21, thereby drifting the ions by the action of the electric fields formed (the accelerating electric field and the decelerating electric field). By allowing a user to set the degree of separation to the highest setting, although it takes time for the ions to drift, it is possible to favorably separate the ions having mobility close to each other.

As has been described above, by maintaining the duty ratio d at a constant and changing the voltage value of the rectangular waveform voltage applied to the annular electrode 21, the degree of separation may be made to be adjustable.

In the ion mobility separation device of the example of embodiment described above, a uniform accelerating electric field and a uniform decelerating electric field are formed by applying the respective different voltages to the plurality of annular electrodes 21 arranged inside the drift tube 2; however, the structure of the electrode can be properly modified so as to allow implementation by conventional ion mobility separation devices. For example, by applying different voltages to both ends of one electrode comprising cylindrical resistors, it is possible to form an electric field with a straight potential gradient in the space inside the cylindrical electrodes on its central axis. Similarly to the example of embodiment described above in the ion mobility separation device using such electrode, it is possible to adjust the degree of separation by applying a rectangular waveform voltage with an adjusted duty ratio to both ends of the electrode.

The example of embodiment described above is merely an example of the present invention; the present invention is not limited to the example of embodiment and various modified examples described above; it shall therefore be readily understood that proper modifications, corrections, and additions within the range of the gist of the present invention are included in the range of the present scope of patent claims.

### EXPLANATION OF REFERENCES

1 . . . Ion source

2 . . . Drift tube

21 . . . Annular electrode

3 . . . Drift region

4 . . . Gate electrode

5 . . . Detector

6 . . . Gate voltage generator

7 . . . Drift voltage generator

8 . . . Control unit

81 . . . Duty ratio determination unit

9 . . . Input unit

C . . . Ion optical axis

What is claimed:

1. An ion mobility separation device for separating ions in their travelling direction depending on the ion mobility by introducing pulsed ions into a drift region to allow drifting, comprising
one or a plurality of electrodes for forming an electric field having a predetermined potential gradient in the central axis in the drift region,
a voltage applying unit for selectively applying to the one or a plurality of electrodes an accelerating voltage so as to form in the drift region an accelerating electric field for accelerating the ions introduced into the drift region along the central axis, and a decelerating voltage so as to form in the drift region a decelerating electric field for decelerating the ions along the central axis, and
a control unit for controlling the voltage applying unit so as to repeat one cycle of applying a decelerating voltage for a second predetermined period after applying an accelerating voltage for a first predetermined period to one or the plurality of electrodes described above, and for adjusting the ratio between the first predetermined period and the second predetermined period in that one cycle.

2. An ion mobility separation device for separating ions in their travelling direction depending on the ion mobility by introducing pulsed ions into a drift region to allow drifting, comprising
one or a plurality of electrodes for forming an electric field having a predetermined potential gradient in the central axis in the drift region,
a voltage applying unit for selectively applying to the one or a plurality of electrodes an accelerating voltage so as to form in the drift region an accelerating electric field for accelerating the ions introduced into the drift region along the central axis, and a decelerating voltage so as to form in the drift region a decelerating electric field for decelerating the ions along the central axis, and
a control unit for controlling the voltage applying unit so as to repeat one cycle of applying a decelerating voltage for a second predetermined period after applying an accelerating voltage for a first predetermined period to one or the plurality of electrodes, and for adjusting at least one value of the accelerating voltage and decelerating voltage.

3. The ion mobility separation device according to claim 1, further comprising
a setter for allowing a user to set an ion separation performance is further provided in the device, wherein
the control unit adjusts the ratio between the first predetermined period and the second predetermined period depending on the separation performance set by the setter, or adjusts at least one of the values of the accelerating voltage and the decelerating voltage.

4. The ion mobility separation device according to claim 2, further comprising
a setter for allowing a user to set an ion separation performance is further provided in the device, wherein
the control unit adjusts the ratio between the first predetermined period and the second predetermined period depending on the separation performance set by the setter, or adjusts at least one of the values of the accelerating voltage and the decelerating voltage.

5. An ion mobility separation method for separating ions in their travelling direction depending on the ion mobility by introducing pulsed ions into a drift region to allow drifting, comprising
selectively applying, to one or a plurality of electrodes or forming an electric field having a predetermined potential gradient in the central axis in the drift region, an accelerating voltage so as to form in the drift region an accelerating electric field for accelerating the ions introduced into the drift region along the central axis, and a decelerating voltage so as to form in the drift region a decelerating electric field for decelerating the ions along the central axis, and
controlling the voltage applying so as to repeat one cycle of applying a decelerating voltage for a second predetermined period after applying an accelerating voltage for a first predetermined period to one or the plurality of electrodes described above, and for adjusting the ratio between the first predetermined period and the second predetermined period in that one cycle.

6. An ion mobility separation method for separating ions in their travelling direction depending on the ion mobility by introducing pulsed ions into a drift region to allow drifting, comprising
selectively applying, to one or a plurality of electrodes for forming an electric field having a predetermined potential gradient in the central axis in the drift region, an accelerating voltage so as to form in the drift region an accelerating electric field for accelerating the ions introduced into the drift region along the central axis, and a decelerating voltage so as to form in the drift region a decelerating electric field for decelerating the ions along the central axis, and
controlling the voltage applying so as to repeat one cycle of applying a decelerating voltage for a second predetermined period after applying an accelerating voltage for a first predetermined period to one or the plurality of electrodes, and for adjusting at least one value of the accelerating voltage and decelerating voltage.

7. The ion mobility separation method according to claim 5, further comprising
allowing a user to set an ion separation performance is further provided in the device, wherein
the ratio between the first predetermined period and the second predetermined period is adjusted depending on the separation performance set by the user, or at least one of the values of the accelerating voltage and the decelerating voltage is adjusted.

8. The ion mobility separation device according to claim 6, further comprising
allowing a user to set an ion separation performance is further provided in the device, wherein
the ratio between the first predetermined period and the second predetermined period is adjusted depending on the separation performance set by the user, or at least one of the values of the accelerating voltage and the decelerating voltage is adjusted,
the control unit adjusts the ratio between the first predetermined period and the second predetermined period depending on the separation performance set by the setter, or adjusts at least one of the values of the accelerating voltage and the decelerating voltage.
